(19) United States
(12) Patent Application Publication
(10) Pub. No.: US 2009/0291162 A1
(43) Pub. Date: Nov. 26, 2009

(54) METHOD AND INJECTION MOLDING MACHINE HAVING A MODULAR STRUCTURE

(75) Inventors: Placi Wenzin, Walenstadt (CH); Daniel Jenny, Oberurnen (CH); Robert Weinmann, Weesen (CH)

Correspondence Address: HENRY M FEIEREISEN, LLC;HENRY M FEIEREISEN, 708 THIRD AVENUE, SUITE 1501, NEW YORK, NY, 10017, US

(73) Assignee: Netstal-Maschinen AG, Nafels (CH)

(21) Appl. No.: 12/441,473

(22) PCT Filed: Sep. 12, 2007
(86) PCT No.: PCT/EP2007/007928

§ 371 Date: Mar. 16, 2009

(30) Foreign Application Priority Data
Sep. 14, 2006 (CH) 2006 01486-06

(51) Int. Cl. B29C 45/10; B29C 45/03

(52) U.S. Cl. 425/567; 425/542

(57) ABSTRACT

The invention relates to a method and an injection-molding machine with modular structure. In the solution proposed, to optimize logistics, in particular transport, the design and the construction of at least the mould-clamping mechanism side (7) and the injection system side (8) of the machine are modular. There are central unitary mounting and coupling interfaces (13 and 14 or 15, 15′, 15′) by way of which a mould-clamping module (1), a system module (16) and a drive module (17) are connected. The three modules can be selected freely from appropriate ranges of mould-clamping modules and system modules and drive modules.

### TECHNICAL FIELD

The invention relates to a method for logistics, the configuration and the structure of injection molding machines at the machine manufacturer, in particular for the production and the transport of injection molding machines, and to an injection molding machine having a two-part structure with an injection unit side.

### STATE OF THE ART

Two concepts have been established with injection molding machines. For practical and logistic reasons, these concepts are based on the total weight of the machines. Injection molding machines with a closing force of up to about 400 tons have a weight of less than 25 tons. They are manufactured as one piece and can be transported in large containers from the manufacturer to the operator of the machines over any distance as a single piece, i.e., undivided. Handling can be accomplished by different means, for example cranes and air cushions, with which loading can be performed without problem. Typically, machines with a closing force of less than 400 tons have outside dimensions so that they can be easily transported by motor vehicles and railroad cars. Conversely, large injection molding machines with a closing force of substantially more than 400 tons are typically transported in two pieces and assembled at the customer site.

Various concepts are implemented with large machines. The substructure is sometimes constructed as a single piece, sometimes in two pieces and transported separately as a mold clamping structure and an injection unit structure. Most manufacturers offering the entire spectrum of smaller, midsize and large machines have implemented correspondingly adapted concepts. The term logistics partially includes handling of “hardware” and processing. Logistics also includes administrative handling and includes the conceptional phase during the development of a machine: when, how and where individual parts are produced, optionally produced for inventory, recalled and assembled. As described before, the way the machine is transported, i.e., either as several pieces or as a one-piece machine, follows from the selected concept. Once the structure of an injection molding machine is conceptionally defined, handling and logistics is largely also determined. The definition of the term handling also includes all manipulation, from the production of the machine parts to the delivery and the installation of the injection molding machine at the customer site. Several conceptual configurations are frequently examined in parallel by the manufacturer. Handling and logistics are then also complex, because the same company must process several concepts. It is an important aspect, if a machine is designed as a single piece and assembled by the manufacturer, or if the machine is assembled at the customer site. In practical applications, both solutions are offered, each having advantages and disadvantages. If the machines are assembled at the customer site, then the manufacturer supplies longitudinal connections as assembly aids, with which the mold clamping side and the injection unit side can be exactly positioned with the appropriate longitudinal orientation. Such longitudinal connections would be unable to withstand, when transported as a single piece, handling, such as lifting with a crane, or moving or placing the machine on uneven support surfaces.

Another, not unimportant aspect, is a protective cover for the entire machine. Practical applications have suggested a large variety of possibilities. Each machine manufacture has several configurations that match the respective machine concept.

As can be seen from the above discussion, each manufacturer incurs significant expenses, from the first discussion with a customer, the conceptual stage, work planning, pre-production, to the final assembly and delivery to the customer. Upon closer scrutiny, some expenses are uneconomical. There is a risk for a company to limit itself to only a single type or a standard line of a single injection molding machine type, because market demand, for example in relation to machines for producing pre-forms, for optical disk manufacture, or the manufacture of other injection molding machines, for example for the producing consumer goods or packaging components, is subject to severe variations.

It is therefore an object of the invention to search for solutions which make both the production and the logistics, especially for the machine manufacturer, more economical without creating problems for the customer.

### SUMMARY OF THE INVENTION

The method of the invention is characterized in that at least the mold clamping side and the injection unit side are designed in modular form with standard assembly and coupling interfaces, and assembled via the coupling interfaces during final assembly into a one-piece injection molding machine.

The injection molding machine of the invention is characterized by a modular structure, wherein the machine bed is constructed in two parts and has standardized assembly and coupling interfaces, which connect the mold clamping side and the injection unit side to form a one-piece injection molding machine.

According to a particular preferred embodiment, the mold clamping side together with a mold clamping bed is selected as a module from a line of mold clamping products and the injection unit with a support element from a line of injection unit products, and connected via a standardized or uniform machine bed coupling interfaces.

The novel invention surprisingly has a large number of advantages, without the adverse effects of conventional solutions. The inventors have recognized that conventional injection molding machines were always optimized to attain a certain goal. For example, the applicant has developed a production-series-related preproduction only for one particular machine type, either in the applicant's factory or by third-party manufacturers. The type and dimensions of each product series need to be determined first, before the components can be determined. The significant advantage of the novel invention is particularly in the following points:
a) one or more lines of components can be defined for each module,
b) the individual modules can be connected via standardized assembly and/or coupling interfaces, such that
c) smaller and midsized machines can be assembled in the manufacturer's factory to one-piece machines and transported as such.

Due to standardization of the interfaces, prefabricated modules can be selected for each of the suitable configured modules from a line of modules and assembled to a customer-specific machine. In this way, the entire logistics, from the first discussion with a customer to the production of the machine, delivery and installation at the customer site, is reduced for the machine manufacturer to a simple task that was unattainable until now. Once the manufacturing and sales price of the individual modules is known, not only can several solutions be offered to the customer at minimal expense, but the production can also be accelerated. The production costs are also reduced, because the largest possible number of identical individual modules can be manufactured. Another significant advantage of the novel solution makes it possible that each module can be manufactured by a different manufacturer, thereby taking advantage of the particular advantages of each manufacturer.
A minimum parts count can be produced, either directly or via a corresponding inventory control.
Expenses for logistics are minimal.
The processing time in the production can be reduced through parallel assembly.
The number of pieces in production can be increased due to multiple use of identical solutions.

The novel invention does not only allow to optimally solve the task, but also allows arbitrary combinations with respect to:
electrically driven machines,
hydraulically driven machines, and
hybrid machines, i.e., the combination of electric and hydraulic drives.

A customer order can be quickly defined and realized from the corresponding lines of modules by selection of:
the magnitude of the closure force,
the size of the injection unit, and
the required drive power.

The novel invention makes possible a significant number of particularly advantageous embodiments. Reference is made to claims 2 to 8, and 10 to 20. According to an advantageous approach, at least small and midsize machines are handled after final assembly as one piece, and transported and installed at the customer also as one piece. Additional handling of the machine at the customer or injection molder occurs as an inseparable machine. Preferably, the mold clamping side together with a mold clamping bed is selected as a first module from a line of mold clamping products, and the injection unit with support element or support tube is selected as second module from a line of injection unit products, with the goal of assembly via standardized installation and/or coupling interfaces. The idea of modular structure thereby far exceeds the component construction employed to this day in practice. With conventional lines of products, the individual machine type is merely subdivided into smaller units. The modular structure considers entire lines of products of different machines and machines of different size, which can be assembled with standardized installation and/or coupling interfaces like Lego® blocks. In a particularly preferred embodiment, the injection module substructure is implemented as a drive module or third module and selected from a line of drive modules. The new concept therefore envisions three lines of modules which can be freely selected and combined already “on paper” or later during manufacture to form an entire machine. Each line of modules has modules of different size and type, for example for the production of optical discs, the production of preforms or for injection molding machines in general for the production of consumer goods or packaging components.

According to an additional contemplated embodiment, the injection unit is implemented as a second module with a support element or support tube, which is connected with the drive module via a standardized assembly or coupling interface. The support tube is fixedly connected with a drive module, so that the injection unit is movable relative to the support tube by corresponding drives. According to another advantageous embodiment, the height of the injection axis can be determined through selection of the mold clamping module, wherein the injection axis with the support tube is connected with the drive module by way of height-adjustable assembly and/or coupling interfaces. In this way, identical lines of products can be used and assembled for machines of types and sizes, which has thus far not been possible.

In a particular preferred embodiment, the mold clamping module is connected to the injection unit side or the drive module in a manner resistant to bending by way of standardized assembly and/or machine bed coupling interfaces, so that an entire machine can be lifted in the assembled state with a hoist and transported. This applies in particular to smaller and midsize machine sizes with a closure force up to about 400 tons.

Advantageously, for transmitting the closing force via the tie rods, the injection unit is connected directly with the nozzle-side platen with the mold clamping module via standardized injection unit interfaces arranged symmetrical to the injection axis.

As a device, the injection molding machine preferably includes
a mold clamping module,
an injection unit module or injection module, and
a drive module.

These three modules can now be selected, assembled and, as described above, manufactured based on a defined standard program or a catalogue with the customer's requirements. It is important that all assembly and coupling interfaces are formed as standardized interfaces.

In particular, an oil reservoir, a pump drive, as well as a chiller and filter, are arranged in or on the drive module; furthermore, a control box is arranged on the drive module. Different from the mold clamping bed, the drive module houses several components having different functions. In particular, these are the components associated with the main drive for a hydraulic machine. For the production of plastic parts, the injection unit is directly connected at the nozzle-site platen with the mold clamping module by way of tie rods which are formed as standardized injection screw interfaces. The tie rods support only a pulling function and must not be subjected to other forces resulting from handling of the entire machine. The mold clamping module is connected in the upper region with the injection unit module via the tie rod interface. In this way, the forces from clamping the mold and from the melt pressure are primarily absorbed in the molds. These operate primarily in the longitudinal direction of the machine.

In a particular preferred embodiment, the mold clamping bed and the injection unit substructure and/or the drive module are connected to a bending-resistant substructure via upper and lower coupling interfaces, such that the mold clamping side and the injection unit side form in the installed state a closed force-parallelogram. The forces, which are generated during handling or transport, for example during lifting with the crane or by a non-uniform support on the shipping crates, are absorbed by the force parallelogram, in particular the standardized coupling interfaces. Importantly, while the machine bed for the injection molding machine, which consists of the mold clamping bed and the injection unit substructure, are formed as two pieces, the machine bed can stay connected as one unit with the mechanical superstructure, so that the entire machine is transported as a unit. The mold clamping module can be preassembled, except for the electrical and hydraulic lines, independent of the injection unit side.

The injection unit is preferably configured as an injection unit module with a support tube, wherein the injection unit or the support tube can be connected with the injection unit substructure via an assembly and/or coupling interface.

According to another advantageous embodiment, the individual modules have independent standardized protective covers:
a mold clamping cover,
a mold clamping bed cover,
an injection unit cover, and
an injection unit substructure cover.

In this way, the protective cover for the entire machine is also constructed according to the modular concept and can be selected from standardized parts. The individual protective covers can also be installed quickly by way of standardized coupling interfaces on the respective modules or supported or screwed on the floor.

Because the novel invention not only relates to the individual manufacture of modules, but also the logistics area which includes handling and transport, injection molding machine with a clamping force greater than 400 tons can be transported in two or more pieces based on the same fundamental concept. As described above, the majority of advantages of the invention, from the first discussion with a customer, to inventory control, module production and initial assembly in the factory of the manufacturer can also be used with the large machines. The components of the injection unit machines with clamping forces substantially greater than 400 tons may then also be assembled at the production site of the customer, preferably employing a reduced number of screw connections between the mold clamping bed and the drive module. Electrical, electronic and hydraulic coupling interfaces can be provided between the mold clamping side and the injection unit side.

According to another embodiment, the height of the injection unit is defined in the context of a standard line of mold clamping devices, whereby height differences relating to the injection unit module and the drive module are compensated by spacers arranged between the injection unit module and the drive module.

### BRIEF DESCRIPTION OF THE INVENTION

The invention will now be described in more detail with reference to several exemplary embodiments:

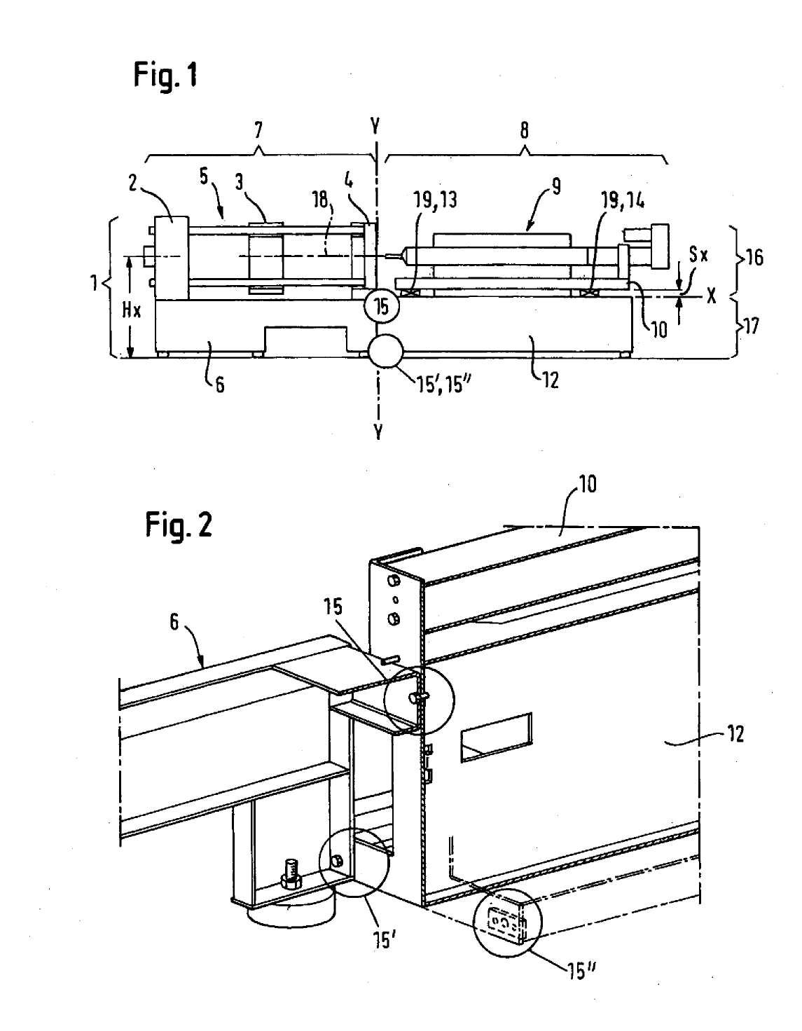

FIG. 1 shows an entire injection molding machine with the mold clamping side and the injection unit side, which can be separated or assembled via the axis Y-Y;

FIG. 2 shows a cross-sectional view with the assembly and/or coupling interfaces between the mold clamping bed and the injection module substructure;

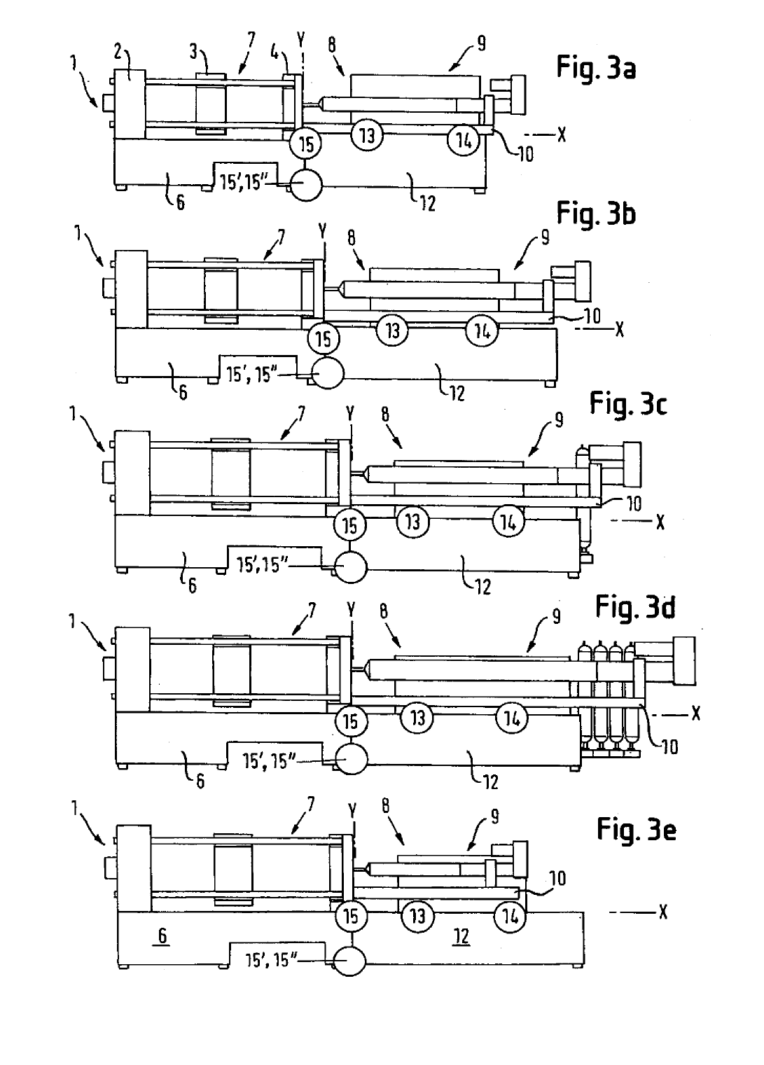

FIGS. 3a to 3e show five different injection molding machines with modules from three lines of modules;

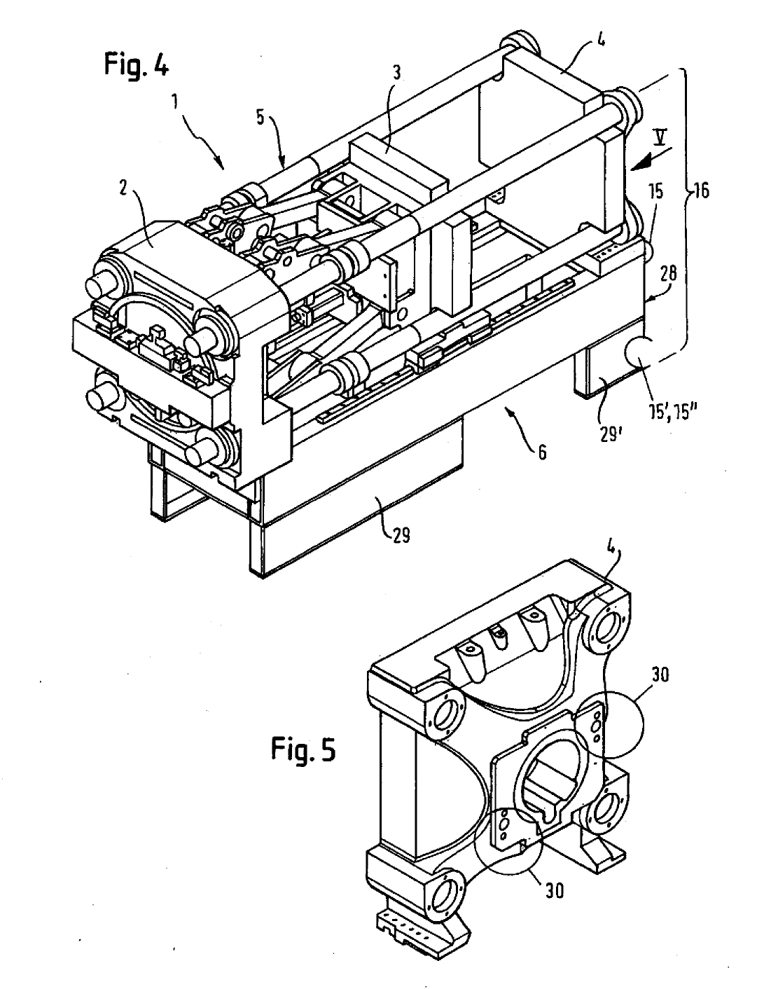

FIG. 4 shows the mold clamping side, designed as mold clamping module with mold clamping bed;

FIG. 5 shows the platen on the injection-nozzle side with standardized tie rod interfaces and corresponding coupling interfaces for the injection unit;

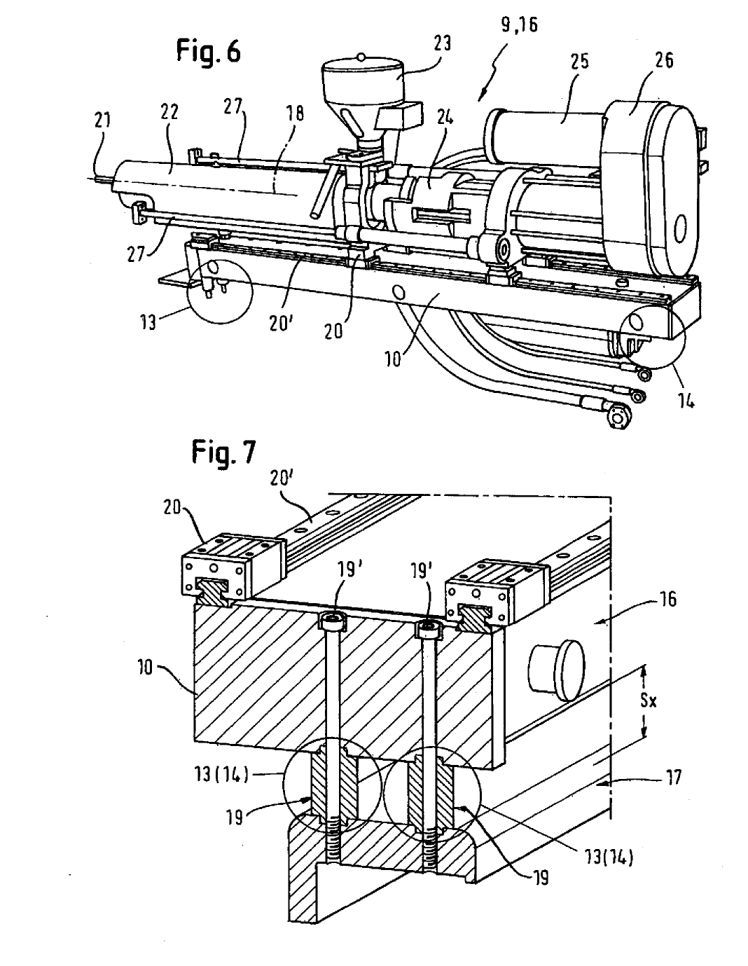

FIG. 6 shows a complete injection unit module with a support element or support tube;

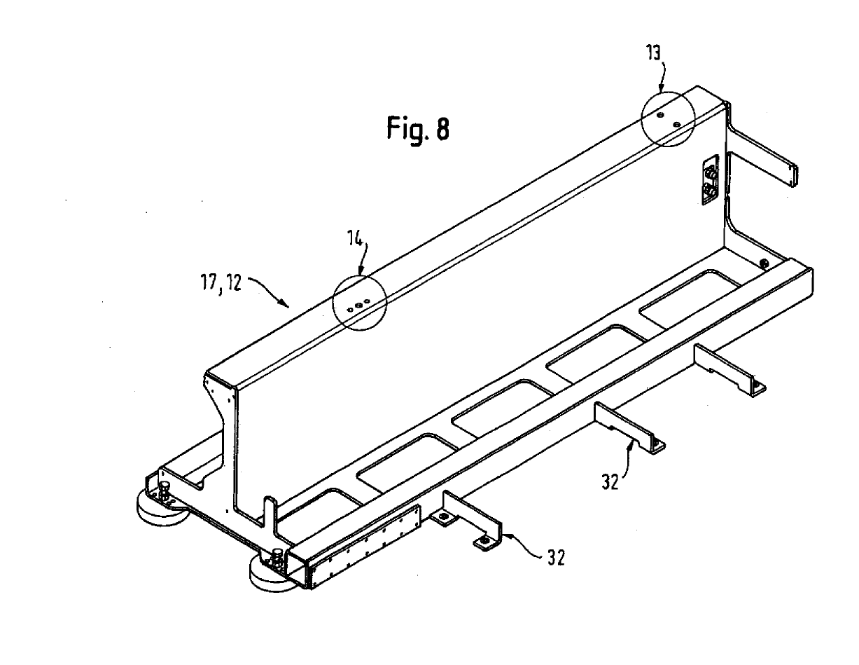

FIG. 7 shows the coupling interfaces between the support tube as injection unit module and the injection module substructure with spacers for compensating height differences;

FIG. 8 is an example of a drive module, on both sides with installation space for an oil reservoir; the main motor with hydraulic pump and oil tank;

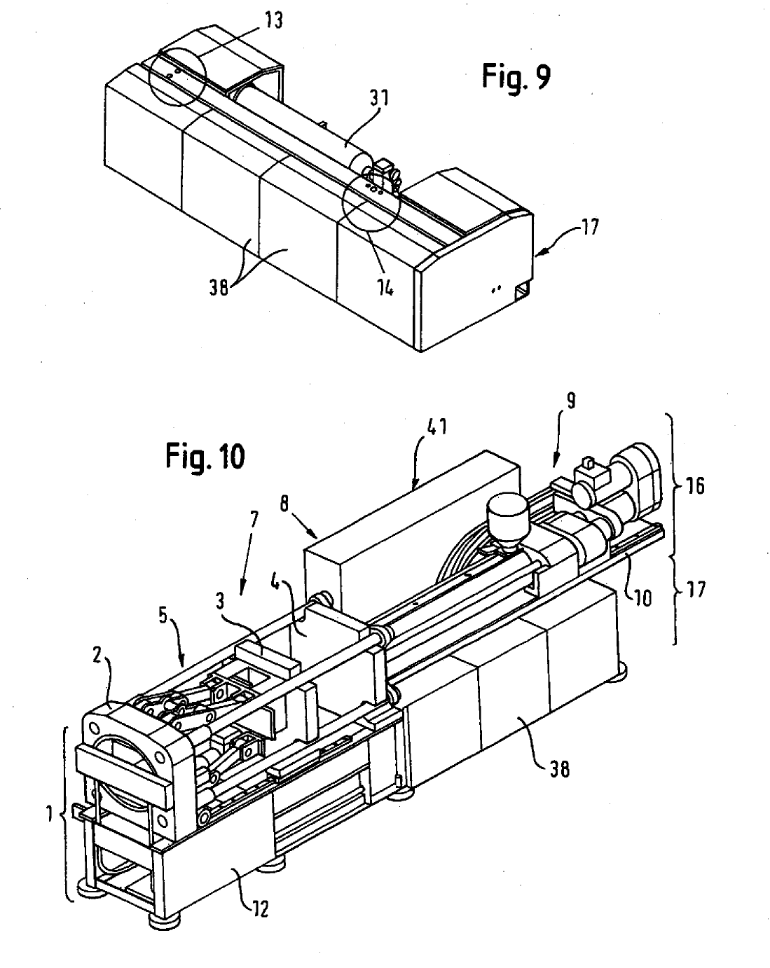

FIG. 9 shows the protective covers in the region of the injection module substructure;

FIG. 10 shows an injection molding machine, with the mold clamping side and the injection unit depicted without protective cover, and the injection module substructure with installed protective cover and the control box in the background.

### APPROACHES AND IMPLEMENTATION OF THE INVENTION

Reference is made hereinafter to FIGS. 1 and 2. FIG. 1 shows the main separation plane Y-Y between the mold clamping side 7 and the injection unit side 8, and also the separation plane X between the injection unit module 16 and the drive module 17. The exact height position Hx is determined when the mold clamping module 1 is defined, which determines both the effective direction of the mold closing force and the corresponding height position for the injection axis 18. Because the injection module substructure 12 and the injection unit 9 themselves have standardized height dimensions, height differences Sx are compensated by spacers 19.

FIG. 2 shows the main interfaces 15, 15′, 15″ between the mold clamping side 7 and the injection unit side 8, and between the mold clamping bed 6 and the injection module substructure 12. The massive coupling interfaces 15, 15′ and 15″ of the two machine bed halves make it possible to transport the machine as a single unit. The coupling interface 15 is arranged in the upper center region of the machine beds. The two coupling interfaces 15′, 15″ are located below on the side. Altogether, a triangular connection is formed, resulting in a bending-resistant connection for the entire machine.

FIGS. 3a to 3e show five examples of injection molding machines according to the concept of the novel invention. X-X and Y indicate the boundary planes of the main modules. On the left side of the Figure, a mold clamping module 1 is illustrated which has a main elements a fixed support plate 2 and a movable platen 3, as well as a platen 4 located on the nozzle side. Not shown is the mold clamping mechanism 5. Below the plates 2, 3 and 4 is a mold clamping bed 6. The injection unit 9, which in conjunction with a support tube 10 forms the injection unit module 16, is shown on the right side of FIG. 3a. The injection unit substructure 12 is located below the injection unit module 16. The injection unit module 16 is connected via assembly and/or coupling interfaces 13 and 14. The assembly and/or coupling interfaces 15, 15′ and 15″ between the mold clamping bed and the drive mode module are indicated with the reference symbols. All machine beds are generally configured in two parts. Transport size and weight determine if the connection is made once during manufacture and the machine is transported as a single unit, or if the machine must be separated into two pieces and is only assembled again when installed at the customer site. FIGS. 3b, 3c, 3d and 3e are four additional examples of different injection molding machines. Important are, in addition to the modular structure, the identical coupling interfaces 13 and 14, and 15, 15′ and 15″, respectively. Modules that fit a desired machine or a certain machine size can be selected from three lines of products:
from a line of mold clamping modules,
from a line of injection unit modules, and
from a line of drive modules.

FIG. 4 shows the entire mold clamping side as mold clamping module 1, including a mold clamping bed 6.
The mold clamping module 1 has an optimized design depending on column distances and platen dimensions (injection axis height, billet opening, machine bed height, width).
Interfaces 15 to the injection module substructure 12 are defined for all quantities.
The standardized coupling interfaces permit use of those screwed positions that are possible with the selected combination.

The injection axis height Hx is defined by the setting of the mold clamping force and/or the resulting mold clamping force on the platens. Any height differences between the injection unit module 16 and the drive module 17 are compensated by spacers 19 (FIG. 1). The mold clamping bed 6 is configured as a sheet-metal structure with two supporting upper flanges 28 and supports 29, 29′.

FIG. 5 shows the nozzle-side platen 4 with the coupling interfaces and/or interfaces 30 to the injection unit 9. The nozzle-side platen 4 includes two interfaces 30 to the tie rods 27 for applying pressure to the injection module.

FIG. 6 shows the injection unit module.
The injection unit 9 in conjunction with a support tube 10 forms the injection unit module 16.
The support tube 10 is supported on the drive module 17 by two coupling interfaces 13, 14 (FIG. 1).
The injection unit 9 is pressed against the platen 4 by centrally arranged tie rods 27 via the interfaces 30.
The nozzle adjustment is performed in a conventional manner by positioning or moving the injection module 9 on the support tube 10.
For all machines, plasticizing with standard interface to the injection module is used.

The injection unit 9 is arranged on the support tube 10 for movement by way of linear guides 20 and guide rails 20′. The injection unit 9 can be moved towards and away from the nozzle-side platen 4, whereby the nozzle tip 21 can be moved in contact with or spaced away from the mold injection opening. The injection unit 9 has as main elements an injection cylinder 22, a feed hopper 23 for the pellets, gears 24 and drives 25 with transmissions 26. Various lines for supply and removal of energy are located below the support tube 10. The lines, which are only schematically indicated, can be implemented in different ways, for example in form of oil hoses, electrical connections, control lines, etc. The novel invention makes it optional to provide suitable subcomponents for economical manufacture.

FIG. 7 shows a coupling interface 13, 14 between the support tube 10 of the injection unit module 16 and the drive module 17. Spacers 19 and screws 19′ compensate height differences Sx.

FIG. 8 shows a drive module 17 in which a tank with a chiller and a filter, and the motor-pump group can be housed. A bubble storage device 31 and a injection module for closed-loop recooling of motors and gears can be arranged on the opposite side. The suspension 32 for a control box 41 is located on the side.

FIG. 9 shows protective covers 38 of the drive module 17. The drive module 17 includes noise protection. Visible are a bubble storage device 31 and the coupling interfaces 13, 14.

FIG. 10 shows the two machine halves, which represent the mold clamping side 7 and the injection unit side 8, assembled to a one-piece injection molding machine. The mold clamping side 7 and the injection unit module 16 are shown without protective covers. Visible on the right side in the background is the control box 41.

A complete injection molding machine has the following protective covers:
a mold clamping cover, and
an injection unit cover, and
an injection unit substructure cover.

The individual modules have independent protective covers. The individual protective covers are designed as standard elements and can be selected from a line of protective covers, with the advantage of large-scale manufacturing and the smallest possible number of individual elements.

1.-20. (canceled)

21. A method for logistics, design and configuration of injection molding machines having different sizes at a machine manufacturer, in particular for manufacture and transport of such injection molding machines, comprising the steps of:
designing a mold clamping side and an injection unit side of an injection molding machine in modular form with a mold clamping module and an injection module having upper and lower assembly or coupling interfaces; and
assembling the mold clamping side and the injection unit side during final assembly to a one-piece injection molding machine by connecting the mold clamping module with the injection module or with a drive module by way of the upper and lower assembly or coupling interfaces, or a combination thereof, so as to form a one-piece injection molding machine having a bending-resistant substructure.

22. The method of claim 21, wherein at least a smaller or midsize injection molding machine is, after final assembly, handled and transported as a single piece and also installed at a customer site as a single piece, and subsequently handled at the customer site or at a user site as an inseparable machine.

23. The method of claim 21, wherein the mold clamping module in conjunction with a mold clamping bed form a first module, and the injection module forms a second module.

24. The method of claim 23, wherein the first module is selected from a line of mold clamping products.

25. The method of claim 23, wherein the second module is selected from a line of injection unit products.

26. The method of claim 21, wherein the drive module or a third module are configured as an injection module substructure.

27. The method of claim 21, wherein the drive module is selected from a line of drives module products.

28. The method of claim 23, wherein the second module comprises an injection unit and a support element, which is connected to the drive module by way of the standardized assembly or coupling interfaces.

29. The method of claim 26, wherein mold clamping module defines an injection axis height, wherein the injection module comprises a support element or a support tube which is connected with the drive module at assembly or coupling interfaces by way of height-adjustable spacers.

30. The method of claim 21, wherein the one-piece injection molding machine is constructed to be lifted and transported with a hoist.

31. The method of claim 21, wherein the injection module defines an injection axis and comprises a nozzle-side platen which is directly connected with the mold clamping module by way of standardized injection unit interfaces arranged symmetrical to the injection axis, for transferring a pressing force to a mold via tie rods.

32. An injection molding machine comprising:
a mold clamping side comprising a mold clamping module,
an injection unit side comprising an injection module, and
a machine bed implemented in two parts having upper and lower assembly and coupling interfaces, with a first part of the machine bed associated with the mold clamping module and a second part of the machine bed associated with the injection module,
the first part of the machine bed and the second part of the machine bed connecting the mold clamping side and the injection unit side, wherein the mold clamping module is connected to the injection unit side or with a drive module by way of the upper and lower assembly and coupling interfaces so as to form a bending-resistant substructure.

33. The injection molding machine of claim 32, wherein the modules of the injection molding machine are finally assembled at a manufacturer site to a one-piece machine.

34. The injection molding machine of claim 32, wherein the injection molding machine comprises at least the mold clamping module, the injection module and the drive module.

35. The injection molding machine of claim 32, wherein the assembly and coupling interfaces are configured as standardized interfaces, allowing the injection unit side, which includes the injection module and the drive module, and the mold clamping module to be freely selected and combined from a corresponding line of products.

36. The injection molding machine of claim 32, wherein the drive module comprises an injection module substructure and drives, wherein the drive module is configured for connection to the injection unit module and the mold clamping module or the mold clamping bed by way of suitably constructed handling or assembly interfaces.

37. The injection molding machine of claim 32, wherein drive module further comprises an oil reservoir, a pump drive, a chiller and a filter.

38. The injection molding machine of claim 32, wherein the drive module further comprises a control box.

39. The injection molding machine of claim 32, wherein the mold clamping module comprises a mold clamping cover, the injection module comprises an injection module cover, and the substructure comprises an injection unit substructure cover.

40. The injection molding machine of claim 32, wherein injection molding machines having a clamping force of greater than 400 tons are transported in two or more separate pieces.

41. The injection molding machine of claim 40, wherein the separate pieces of the injection molding machines having a clamping force of greater than 400 tons are assembled from the two or more separate pieces at a customer site.

42. The injection molding machine of claim 41, wherein assembly at the customer site uses a reduced number of screw connections between the first part of the machine bed and the drive module.

43. The injection molding machine of claim 32, further comprising at least one of an electric, an electronic and a hydraulic coupling or interface disposed between the mold clamping side and the injection unit site.

44. The injection molding machine of claim 32, wherein the injection unit side has a standardized height and the injection unit is supported by a support element or support tube, further comprising spacers compensating a height difference between the support element or support tube and the drive module.
